(19) United States
(12) Patent Application Publication
(10) Pub. No.: US 2026/0330376 A1
(43) Pub. Date: Oct. 22, 2026

(54) MEASUREMENT SYSTEM AND METHODS FOR DETECTING PAYLOAD DROP RISKS

(71) Applicant: F.L. WALZ INC., East Peoria, IL (US)

(72) Inventors: Matthew Walz, East Peoria, IL (US); Lars Pehrson, East Peoria, IL (US)

(21) Appl. No.: 19/541,011

(22) Filed: Feb. 16, 2026

Related U.S. Application Data
(60) Provisional application No. 63/792,456, filed on Apr. 22, 2025.

(51) Int. Cl. G06Q 10/0635; G06T 7/13; G06V 10/25

(52) U.S. Cl. CPC G06Q 10/0635; G06T 7/13; G06V 10/25; G06T 2207/10028

(57) ABSTRACT

A system for detecting a payload drop risk. The system includes a first sensor configured to generate a signal constituting data representing a payload and a processor configured to determine drop risk data points from the data representing the payload.

### RELATED APPLICATIONS

This regular utility non-provisional patent application claims priority benefit with regard to all common subject matter, of earlier-filed U.S. Provisional Patent Application Ser. No. 63/792,456, filed on Apr. 22, 2025, and entitled “MEASUREMENT SYSTEM AND METHODS FOR DETECTING PAYLOAD DROP RISKS”. The identified earlier-filed provisional patent application is hereby incorporated by reference in its entirety into the present patent application.

### BACKGROUND

Carrier devices such as trucks, rail cars, conveyor systems, and the like are often loaded with a payload of material that cannot be tied down or enclosed. The carrier devices are sometimes loaded with too much material or haphazardly such that some of the payload may fall or become dislodged from the carrier device, thus presenting a drop risk. Dropped payload may be hazardous to equipment (including the carrier device), other vehicles, roadways, and/or humans and takes effort to recollect. Operators, such as a driver of the carrier device, often do not assess payloads for drop risks (sometimes for expediency), do not notice drop risks, or are not trained to identify drop risks. Furthermore, some drop risks are difficult for humans to identify regardless of human diligence.

### SUMMARY OF THE INVENTION

Embodiments of the present invention solve the above-mentioned problems and provide a distinct advance in the art of material transportation. More particularly, the present invention provides a system that automatically detects payload drop risks.

An embodiment of the present invention is a system for detecting a payload drop risk. The system broadly comprises a first sensor configured to generate a signal constituting data representing a payload and a processor configured to determine drop risk data points from the data representing the payload.

Another embodiment is a method of detecting a payload drop risk. The method broadly comprises a step of generating a signal constituting data representing a payload and a step of determining drop risk data points from the data representing the payload.

Another embodiment is a method of detecting a payload drop risk. The method includes a step of generating a signal constituting data representing a vehicle. The method further includes a step of identifying a first region of interest from the data representing the vehicle, the first region of interest including data corresponding to a vehicle boundary, and disregarding data representing the vehicle not included in the first region of interest. The method further includes a step of generating a signal constituting data representing a payload. The data representing the payload is in the form of at least one of a raster representation, a three-dimensional point cloud, a vector representation, and a three dimensional image. The method further includes a step of identifying a second region of interest from the data representing the payload, the second region of interest including data corresponding to a payload boundary, and disregarding data representing the payload not included in the second region of interest. The method further includes a step of comparing the data corresponding to the payload boundary in the second region of interest and the data corresponding to the vehicle boundary in the first region of interest thereby determining drop risk data points. The method further includes a step of indicating a drop risk is detected upon a number of detected drop risk data points exceeding a threshold value.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a front elevation view of a vehicle and a payload for use with the present invention;

FIG. 2 is a front elevation view of a vehicle and a payload for use with the present invention;

FIG. 3 is a front elevation view of a payload drop risk detection system constructed in accordance with an embodiment of the invention;

FIG. 4 is a front elevation view of the payload drop risk detection system of FIG. 3;

FIG. 5 is a schematic diagram of certain components of the payload drop risk detection system of FIG. 3;

FIG. 6 is flow diagram of certain steps of a method of detecting a payload drop risk via the payload drop risk detection system of FIG. 3;

FIG. 7 is a graphical representation of data generated by the payload drop risk detection system of FIG. 3 in accordance with an embodiment of the invention; and

FIG. 8 is a graphical representation of data generated by the payload drop risk detection system of FIG. 3 in accordance with an embodiment of the invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION

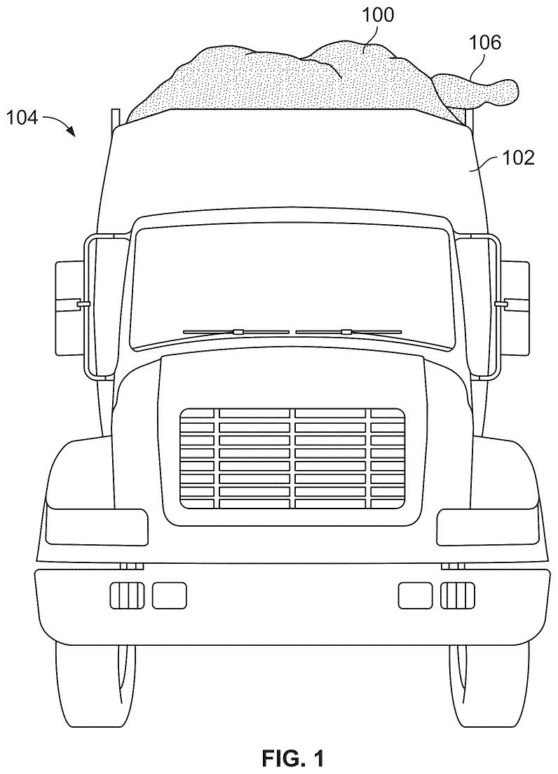

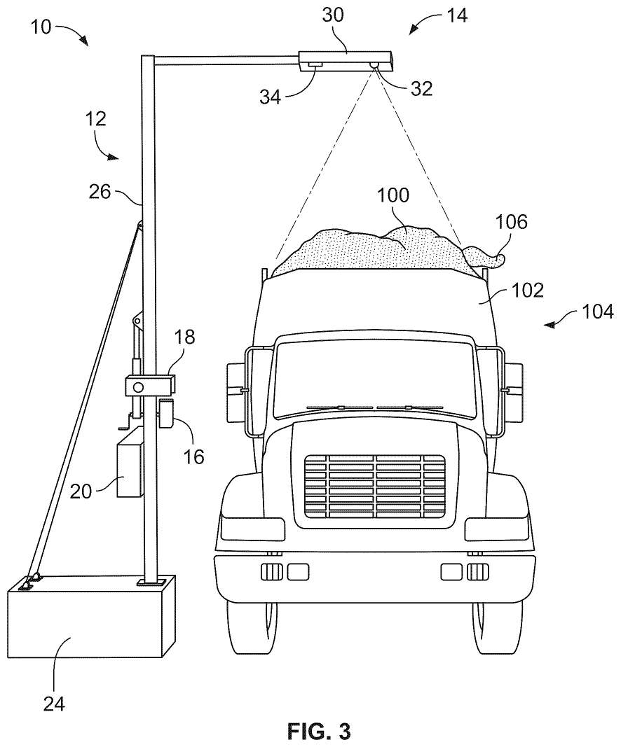

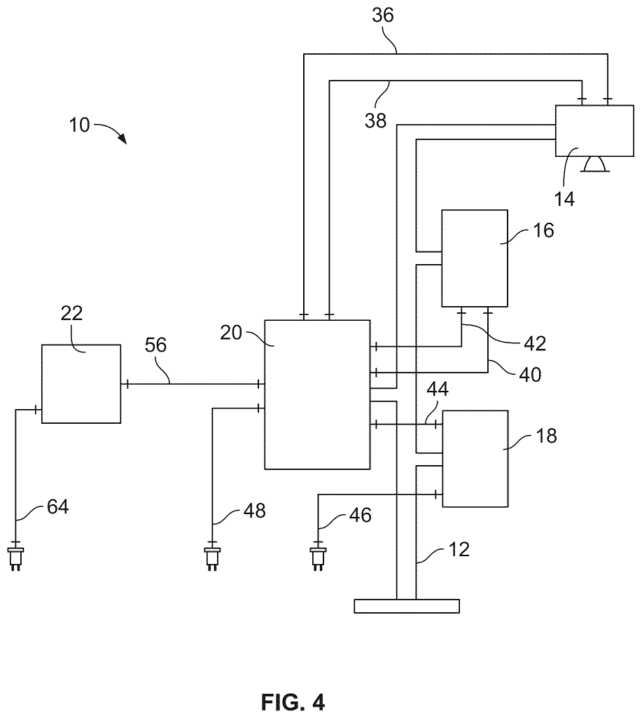

Turning to FIGS. 1-5, a payload drop risk detection system 10 (FIGS. 3-5) constructed in accordance with an embodiment of the invention will now be described. The payload drop risk detection system 10 broadly comprises a frame 12, a scanner 14, an RFID reader 16, a traffic signaler 18, a network unit 20, and a computer 22. The payload drop risk detection system 10 may be used to a detect drop risk of a payload 100 of sand, gravel, marl, clay, topsoil, mulch, silt, peat, rocks, concrete chunks, wood, waste material, organic material, or any other transportable material.

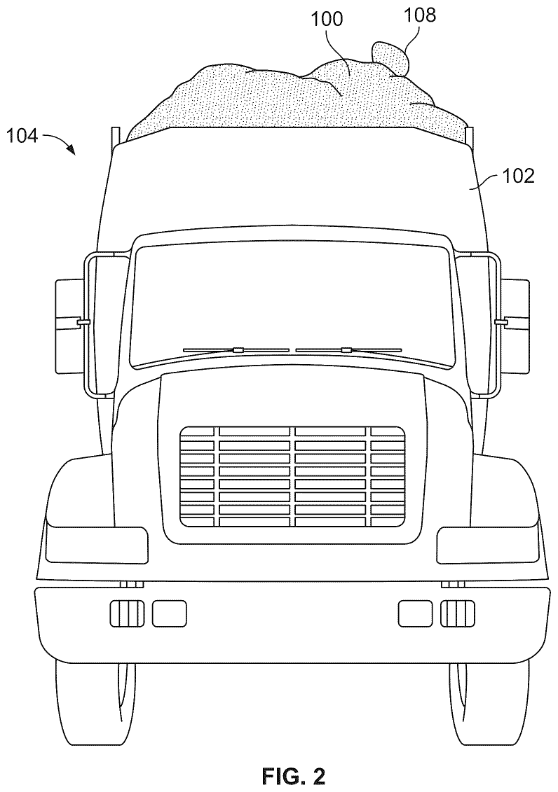

The payload 100 may be loaded in a payload bed 102 of a carrier device 104 such as a truck (FIGS. 1-3), a trailer, a conveyor system, a rail car of a train, or the like. The payload 100 may include dirt, gravel, rocks, concrete chunks, wood, raw material, refuse, garbage, animals, produce or other agricultural products, or any other suitable payload. At least a portion of the payload 100 may pose a payload drop risk, such as the rock 106 shown in FIGS. 1 and 3 or the rock 108 shown in FIG. 2.

The frame 12 supports electronic components of the payload measurement system 10 and may include a base 24, a vertical member 26, and a horizontal member 28. The frame 12 may be positioned near a drivable path, parking location, or bay for scanning a truck load or trailer load or near rail tracks for scanning a railcar load. To that point, the vertical member 26 may support the horizontal member in an elevated position with the horizontal member 28 extending over the drivable path, parking location, bay, or rail tracks.

The scanner 14 may include a hood 30, a first sensor 32, and a second sensor 34. The scanner 14 may be mounted on a distal end of the horizontal member 28. The scanner 14 may be communicatively connected to the network unit 20 via a communication cable 36 and a power cable 38. Alternatively, the scanner 14 may be in wireless communication with the network unit 20 or the computer 22. In some embodiments, the scanner 14 may include only the first sensor 32 and thus may be considered to be the first sensor 32.

The hood 30 may house the first sensor 32 and second sensor 34. In one embodiment, the hood 30 also houses the RFID reader 16.

The first sensor 32 may be oriented to scan a width of the payload bed 102. The first sensor 32 may be a laser sensor (e.g., infrared laser scanner), LiDAR sensor, stereo camera, structured light sensor, or the like. The first sensor 32 may be configured to provide a signal or signals constituting data representing the payload 100 and payload bed 102.

The second sensor 34 may be oriented to scan a length of the payload bed 102. The second sensor 34 may be a laser sensor (e.g., infrared laser scanner), LiDar sensor, stereo camera, structured light sensor, or the like. Together, the first sensor 32 and second sensor 34 are configured to provide a 3-dimensional data representation of the payload 100 and payload bed 102. In one embodiment, the second sensor 34 is omitted if the length of the payload bed 102 is known or determined by other means. In one embodiment, the first sensor 32 and the second sensor 34 may be oriented along different directions from each other to generate 3-dimensional data or at least data along the different directions.

The RFID reader 16 is configured to detect RFID transmissions or RFID fields from badges, ID decals, certificates, RFID chips, or the like to obtain metadata identifying loads to be scanned, trucks or railcars associated with the loads, or other information. The RFID reader 16 is also configured to transmit the metadata to the computer 22. The RFID reader 16 may be mounted on the vertical member 26 at windshield height or in the hood 30. The RFID reader 16 may be communicatively connected to the network unit 20 via a communication cable 40 and a power cable 42. Other vehicle identification mechanisms such as Automatic Number Plate Recognition (ANPR), barcode reading, Optical Character Recognition (OCR), manual operator input, and the like may be used.

The traffic signaler 18 generates light signals, audio signals, or the like to instruct a vehicle or railcar mover operator or driver to advance the payload (to be in range of the sensors 32, 34) or stop. In one embodiment the traffic signaler 18 may be mounted at windshield height for optimal visibility. The traffic signaler 18 may be communicatively connected to the network unit 20 via a communication cable 44. The traffic signaler 18 may also be powered by external power (e.g., 115 VAC, 230 VAC, 24 VDC, or similar) via a power cable 46.

The network unit 20 routes communications and electronic power between the scanner 14, RFID reader 16, traffic signaler 18, and computer 22. The network unit 20 may be a modem, router, computing terminal, server, or the like, and may be communicatively connected to the computer 22 via a communication cable 56. The network unit 20 may also be powered via a 115 VAC power cable 48.

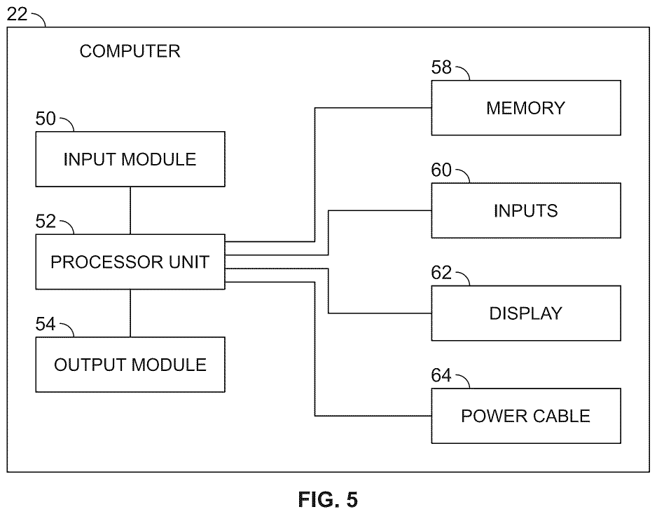

Turning to FIG. 5, the computer 22 may include a raster input module 50, a processor unit 52, and a raster output module 54. The computer 22 may also include a memory 58, a plurality of inputs 60, a display 62, external connectors, transceivers, a power cable 64, and the like.

The raster input module 50 is configured to receive surface raster data (data representative of a surface of the payload 100) or similar data from the first sensor 32 and second sensor 34. The raster input module 50 is also configured to communicate the surface raster data to the processor unit 52 for processing.

The processor unit 52 may implement aspects of the present invention with one or more computer programs stored in or on computer-readable medium residing on or accessible by the processor. Each computer program preferably comprises an ordered listing of executable instructions for implementing logical functions in the processor. Each computer program can be embodied in any non-transitory computer-readable medium, such as the memory 58 (described below), for use by or in connection with an instruction execution system, apparatus, or device, such as a computer-based system, processor-containing system, or other system that can fetch the instructions from the instruction execution system, apparatus, or device, and execute the instructions.

The raster output module 54 is configured to receive surface raster data from the processor unit 52. The raster output module 54 may also be configured to present the surface raster data via the display 62 or transmit the data to a desired computing device.

The memory 58 may be any computer-readable non-transitory medium that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The inputs 60 may comprise a keyboard, mouse, trackball, touchscreen, buttons, dials, virtual inputs, and/or a virtual reality simulator. The inputs 60 allow a user to activate and control components of the payload measurement system 10.

The display 62 may present virtual inputs, data spreadsheets and data tables, graphical data representations, computer models of the payload 100 and payload bed 102, fastener maps, and other information. The display 62 may be a touchscreen, an LCD screen, an LED screen, and the like.

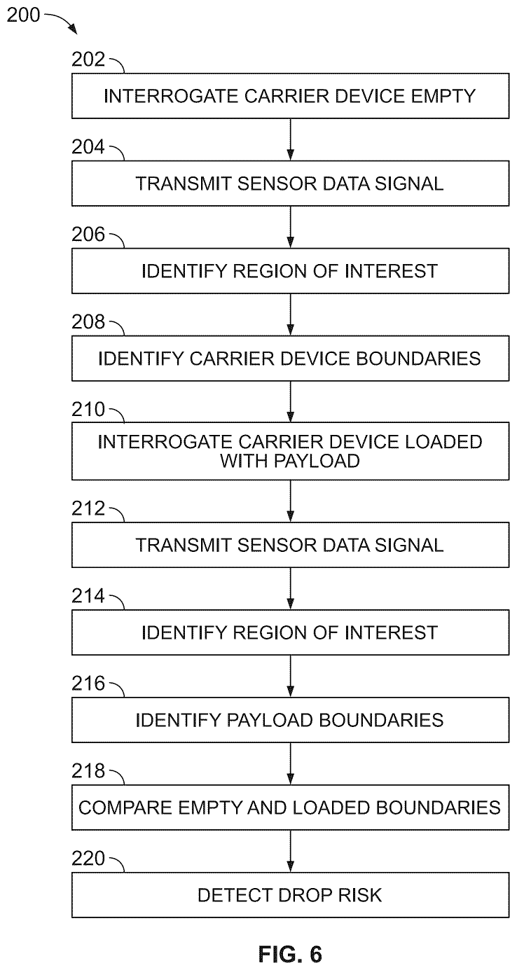

Turning to FIG. 6 and with reference to FIGS. 1-5, 7, and 8, a method 200 of detecting a payload drop risk will now be described in detail. First, the processor unit 52 may interrogate the carrier device 104 via the first sensor 32 and/or the second sensor 34 with the carrier device 104 in an unloaded state (i.e., without a payload), as shown in block 202. To that end, the carrier device 104 may drive under the first sensor 32 and/or the second sensor 34 for an optimal vantage of the payload bed 102. Alternatively, the first sensor 32 and/or the second sensor 34 may be moved or positioned relative to a stationary carrier device 104.

The first sensor 32 and/or the second sensor 34 may then transmit a signal constituting sensor data representing the empty carrier device 104 to the processor unit 52, as shown in block 204. The sensor data may be in the form of, or converted to the form of, at least one of a raster representation, a three-dimensional point cloud, a vector representation, and a three-dimensional image. The sensor data may include data corresponding to a vehicle boundary.

The processor unit 52 may then identify a region of interest (e.g., the payload bed 102) from the data representing the unloaded carrier device 104 and disregard data not included in the region of interest, as shown in block 206. In this way, the processor unit 52 does not need to consider irrelevant data (e.g., data corresponding to a cab of the carrier device 104 or data corresponding to environmental areas near the carrier device 104).

The processor unit 52 may then identify a vehicle boundary (or more specifically, a payload bed boundary) of the unloaded carrier device 104 in the region of interest, as shown in block 208. This may include generating data representing the payload boundary or identifying data as corresponding to the payload boundary. The payload bed boundary may be used to show a drop risk if a payload overlaps the payload bed boundary or is above a predetermined slope relative to the payload bed boundary as described below. The carrier device 104 may then be loaded with the payload 100.

The processor unit 52 may then interrogate the carrier device 104 via the first sensor 32 and/or the second sensor 34 with the carrier device 104 having a payload 100, as shown in block 210. This may be similar to block 202 in that the carrier device 104 may drive under the first sensor 32 and/or the second sensor 34 for an optimal vantage of the (now loaded) payload bed 102 or first sensor 32 and/or the second sensor 34 may be moved or positioned relative to a stationary carrier device 104.

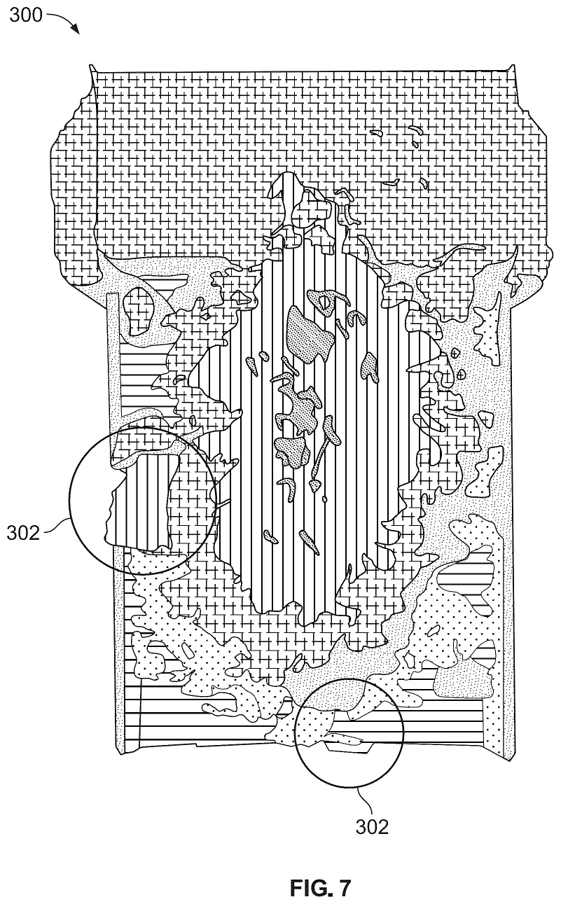

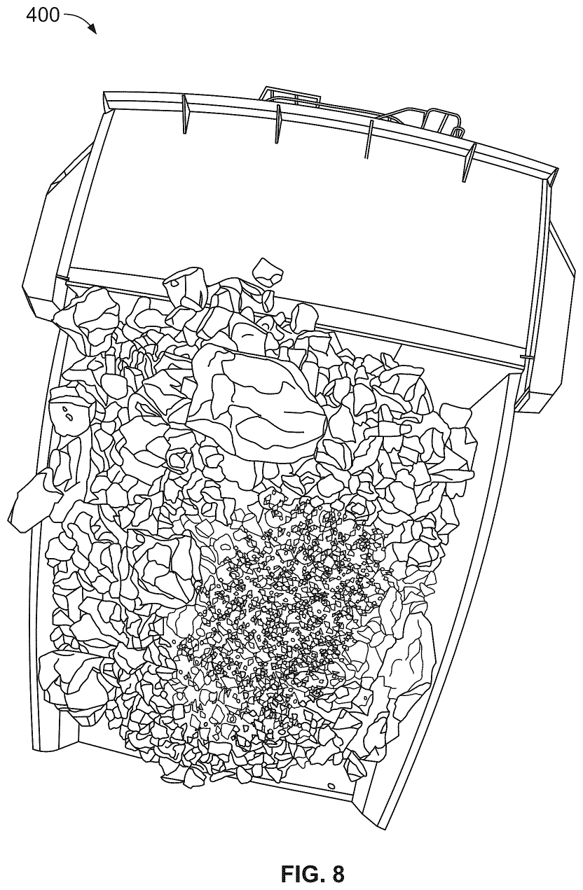

The first sensor 32 and/or the second sensor 34 may then transmit a signal constituting sensor data representing the payload 100 (and optionally the loaded carrier device 104) to the processor unit 52, as shown in block 212. As in block 204, the sensor data may be in the form of, or converted to the form of, at least one of a raster representation, a three-dimensional point cloud (see FIG. 7), a vector representation, and a three-dimensional image (see FIG. 8). The sensor data may include data corresponding to a payload boundary.

The processor unit 52 may then identify a region of interest (e.g., the payload bed 102 or a particular object such as the rock 106 or rock 108) from the data representing the loaded carrier device 104 and the payload 100 and disregard data not included in the region of interest, as shown in block 214.

The processor unit 52 may then identify a payload boundary or boundaries in the region of interest, as shown in block 216. This may include generating data corresponding to the payload boundary or identifying data as corresponding to the payload boundary.

The processor unit 52 may then compare the payload boundary and the vehicle boundary and/or determine drop risk data points from the data representing the payload, as shown in block 218. This may include comparing a position of the payload boundary and a position of the vehicle boundary, comparing an area of the payload and the vehicle boundary, calculating a size of the payload or a size of a portion of the payload (e.g., calculating a size of the rock 106) calculating a slope between the payload boundary and the vehicle boundary (e.g., calculating a slope between the rock 108 and the vehicle boundary). The comparison may also include weighing several factors such as a position of the payload boundary, a distance between the payload boundary and the vehicle boundary, a size of the payload or a size of a portion of the payload, a slope between the payload boundary and the vehicle boundary, a shape of the payload or a shape of a portion of the payload, or the like.

The processor unit 52 may then detect a drop risk based on the comparison, as shown in block 220. For example, the processor unit 52 may determine the payload boundary overlaps (extends beyond) the vehicle boundary by more than a predetermined distance, a greater portion of the payload boundary overlaps the vehicle boundary more than a predetermined amount, a slope between the payload boundary and the vehicle boundary is greater (steeper) than a predetermined ratio, the payload boundary is higher than the vehicle boundary by more than a predetermined amount, a number of detected drop risk data points exceeding a threshold value, a combination of any of the above determinations, or the like. In one embodiment, the drop risk data points may be data points of the data corresponding to the payload boundary that overlap or are external to the data corresponding to the vehicle boundary (e.g., a portion of the payload is hanging over a side of the vehicle). In another embodiment, the drop risk data points are data points of the data corresponding to the payload boundary that are internal to the data corresponding to the vehicle boundary and have a distance from the data corresponding to the vehicle boundary smaller than a predetermined threshold (e.g., a portion of the payload is too close to the edge of the vehicle). The processor unit 52 may also qualify the drop risk such as “high drop risk”, “medium drop risk”, low drop risk”, or the like.

The processor unit 52 may also alert an operator as to the determination or non-determination of a drop risk. For example, the processor unit 52 may transmit a signal representing a drop risk has been detected, generate an alarm, activate a light, display a warning, or provide any other suitable indication that a drop risk has been detected.

The above-described invention provides several advantages. For example, the system 10 automatically detects drop risks without the need for a driver of the carrier device 104 to exit the vehicle. The system 10 can detect drop risks for a series of carrier devices 104 such as in the case of rail cars of a train, a conveyor system, a fleet of trucks, or the like, thereby integrating drop risk detection with minimal disruption of carrier device operation. The system 10 may also detect drop risks that would not be apparent or easily apparent to a human inspector. For example, a human inspector may pass (i.e., not detect a drop risk for) a carrier device having a rock within a vehicle boundary, whereas the system 10 may determine the rock is a drop risk given a steep slope between the rock and the vehicle boundary.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as communication elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing”, “computing”, “calculating”, “determining”, “presenting”, “displaying”, or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises”, “comprising”, “includes”, “including”, “has”, “having”, or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for detecting a payload drop risk, the system comprising:
a first sensor configured to generate a signal constituting data representing a payload; and
a processor configured to determine drop risk data points from the data representing the payload.

2. The system of claim 1, wherein the data representing the payload includes data corresponding to a payload boundary, and wherein the processor is configured to determine the drop risk data points from the data corresponding to the payload boundary.

3. The system of claim 2, the first sensor being further configured to generate a signal constituting data corresponding to a vehicle boundary, the processor being further configured to determine the drop risk data points by comparing the data corresponding to the vehicle boundary and the data corresponding to the payload boundary.

4. The system of claim 3, wherein the drop risk data points are data points of the data corresponding to the payload boundary that overlap or are external to the data corresponding to the vehicle boundary.

5. The system of claim 3, wherein the drop risk data points are data points of the data corresponding to the payload boundary that are internal to the data corresponding to the vehicle boundary and have a distance from the data corresponding to the vehicle boundary smaller than a predetermined threshold.

6. The system of claim 1, wherein the processor is configured to determine the drop risk data points via determining a slope of the payload from the data representing the payload is greater than a predetermined threshold.

7. The system of claim 1, wherein the processor is configured to indicate a drop risk is detected upon a number of detected drop risk data points exceeding a threshold value.

8. The system of claim 1, wherein the processor is configured to identify a region of interest from the data representing the payload and disregard data representing the payload not included in the region of interest.

9. The system of claim 3, wherein the processor is configured to identify a region of interest from the data corresponding to the vehicle boundary and disregard data corresponding to the vehicle boundary not included in the region of interest.

10. The system of claim 1, further comprising a second sensor configured to generate a signal constituting data representing the payload, wherein the first sensor and the second sensor are oriented along different directions from each other, and wherein the data representing the payload is in the form of at least one of a raster representation, a three-dimensional point cloud, a vector representation, and a three dimensional image.

11. A method of detecting a payload drop risk, the method comprising:
generating a signal constituting data representing a payload; and
determining drop risk data points from the data representing the payload.

12. The method of claim 11, wherein the data representing the payload includes data corresponding to a payload boundary, and wherein the determining step includes determining the drop risk data points from the data corresponding to the payload boundary.

13. The method of claim 12, further comprising a step of generating a signal constituting data corresponding to a vehicle boundary, wherein the determining drop risk data points includes comparing the data corresponding to the vehicle boundary and the data corresponding to the payload boundary.

14. The method of claim 13, wherein the drop risk data points are data points of the data corresponding to the payload boundary that overlap or are external to the data corresponding to the vehicle boundary.

15. The method of claim 13, wherein the drop risk data points are data points of the data corresponding to the payload boundary that are internal to the data corresponding to the vehicle boundary and have a distance from the data corresponding to the vehicle boundary smaller than a predetermined threshold.

16. The method of claim 11, wherein the determining step includes determining a slope of the payload from the data representing the payload is greater than a predetermined threshold.

17. The method of claim 11, further comprising a step of indicating a drop risk is detected upon a number of detected drop risk data points exceeding a threshold value.

18. The method of claim 11, further comprising a step of identifying a region of interest from the data representing the payload and disregarding data representing the payload not included in the region of interest.

19. The method of claim 13, further comprising steps of:
identifying a region of interest from the data corresponding to the vehicle boundary and disregarding data corresponding to the vehicle boundary not included in the region of interest; and
indicating a drop risk is detected upon a number of detected drop risk data points exceeding a threshold value,
wherein the data representing the payload is in the form of at least one of a raster representation, a three-dimensional point cloud, a vector representation, and a three dimensional image.

20. A method of detecting a payload drop risk, the method comprising:
generating a signal constituting data representing a vehicle;
identifying a first region of interest from the data representing the vehicle, the first region of interest including data corresponding to a vehicle boundary, and disregarding data representing the vehicle not included in the first region of interest;
generating a signal constituting data representing a payload,
wherein the data representing the payload is in the form of at least one of a raster representation, a three-dimensional point cloud, a vector representation, and a three dimensional image;
identifying a second region of interest from the data representing the payload, the second region of interest including data corresponding to a payload boundary, and disregarding data representing the payload not included in the second region of interest;
comparing the data corresponding to the payload boundary in the second region of interest and the data corresponding to the vehicle boundary in the first region of interest thereby determining drop risk data points; and
indicating a drop risk is detected upon a number of detected drop risk data points exceeding a threshold value.
